(19) United States
(12) Patent Application Publication
(10) Pub. No.: US 2022/0115893 A1
(43) Pub. Date: Apr. 14, 2022

(54) SMART BATTERY FAST CHARGING

(71) Applicant: QUALCOMM INC, SanDiego, CA (US)

(72) Inventor: Xiaofeng LING, Beijing (CN)

(21) Appl. No.: 17/424,217

(22) PCT Filed: Jan. 21, 2019
(86) PCT No.: PCT/CN2019/072579

§ 371 Date: Jul. 20, 2021

(51) Int. Cl. H02J 7/00

(52) U.S. Cl. CPC H02J 7/00714; H02J 7/0071; H02J 7/007192

(57) ABSTRACT

In certain aspects, a method for a battery charging in a wireless device comprises obtaining a fast charging condition; determining a current condition of the wireless device; and enabling or disabling the fast charging by comparing the current condition with the fast charging condition.

### BACKGROUND

### Field

Aspects of the present disclosure relate to battery charging, and more particularly, to apparatuses and methods for fast charging a battery in selected circumstances.

### Background

Cellular and wireless communication technologies have seen explosive growth over the past several years. This growth has been fueled by better communications hardware, larger networks, and more reliable protocols. Wireless service providers are now able to offer their customers an ever-expanding array of features and services, and provide users with unprecedented levels of access to information, resources, and communications. To keep pace with these service enhancements, wireless devices (e.g., cellular phones, tablets, laptops, etc.) have become faster and more powerful than ever, and now commonly include multiple processors, system-on-chips (SoCs), memories, and other resources (e.g., power rails, etc.) that support high-speed communications and allow device users to execute complex and power intensive software applications on their wireless devices.

While the performance demands of wireless devices are increasing, device users expect to maintain certain levels of responsiveness and battery life on their wireless devices. Maintaining these expected levels of performance on a wireless device may result in increased power consumption on the wireless device, which demands a large battery size and fast charging capability. Most wireless devices today support a way of fast charging, such as Quick Charge. Most of the fast charging technologies use a high current or high voltage, often the maximum current or maximum voltage available to quickly pump the energy into the battery. However, such a high current and/or high voltage stresses the battery and reduce the battery lifetime. Therefore, it is beneficial to fast charge the battery only in appropriate and needed circumstances.

### SUMMARY

The following presents a simplified summary of one or more implementations to provide a basic understanding of such implementations. This summary is not an extensive overview of all contemplated implementations, and is intended to neither identify key nor critical elements of all implementations nor delineate the scope of any or all implementations. The sole purpose of the summary is to present concepts relate to one or more implementations in a simplified form as a prelude to a more detailed description that is presented later.

In one aspect, a method for a battery charging in a wireless device comprises obtaining a fast charging condition; determining a current condition of the wireless device; and enabling or disabling a fast charging by comparing the current condition with the fast charging condition.

In another aspect, a wireless device comprises a battery and a controller configured to obtain a fast charging condition; determine a current condition of the wireless device; and enable or disable a fast charging by comparing the current condition with the fast charging condition.

To accomplish the foregoing and related ends, one or more implementations include the features hereinafter fully described and particularly pointed out in the claims. The following description and the annexed drawings set forth in detail certain illustrative aspects of the one or more implementations. These aspects are indicative, however, of a few of the various ways in which the principles of various implementations may be employed, and the described implementations are intended to include all such aspects and their equivalents.

### BRIEF DESCRIPTION OF THE DRAWINGS

FIG. 1 illustrates an exemplary wireless device according to certain aspects of the present disclosure.

FIG. 2 illustrates an exemplary system according to certain aspects of the present disclosure.

FIG. 3 illustrates an exemplary method for battery charging scheme control according to certain aspects of the present disclosure.

### DETAILED DESCRIPTION

The detailed description set forth below, in connection with the appended drawings, is intended as a description of various aspects and is not intended to represent the only aspects in which the concepts described herein may be practiced. The detailed description includes specific details for the purpose of providing an understanding of the various concepts. However, it will be apparent to those skilled in the art that these concepts may be practiced without these specific details. In some instances, well-known structures and components are shown in block diagram form in order to avoid obscuring such concepts.

Today, wireless devices have become bigger with a larger display and the battery size has increased because of the high energy required to run big screens, GPS and multiple applications that run on an internet connection. To support such an increased energy demand, fast charging is a must-have feature in today's wireless devices. In recent years, fast charging solutions such as Quick Charge, Dash Charge, and SuperCharge have evolved to keep up with the needs. They can charge the wireless device up to 60% in just 30 minutes.

Many of the wireless devices use a Lithium-Ion (Li-Ion) battery, which charges 500-2500 times, depending on how users take care of the battery and the charging techniques used. Such a rechargeable battery suffers from stress when exposed to heat, so does keeping a cell at a high charge voltage or charge current. A battery dwelling above 30° C. (86° F.) is considered elevated temperature and for most Lithium-ion battery a voltage above 4.10 V/cell is deemed as high voltage. Exposing the battery to high temperature and dwelling in a full state-of-charge for an extended time can shorten the battery lifetime. The average phone battery lasts 2-3 years at best, some is even shorter.

Fast charging provides flexibility and mobility to the wireless device users. However, in many occasions, fast charging is not needed or should be avoided. For example, when a user is at home or at office, the user is most likely to stay there for a while and there may be sufficient time to charge the wireless device at regular pace without a need to turn on the fast charging. Many wireless device users plug in their wireless devices for charging at nighttime while they are sleeping. Plenty time is available to charge the battery. Some users may plug in the wireless devices for charging even when the battery level is high, such as over 50%.

On the other hand, there are occasions when the fast charging is desired. For example, when a user is on the road, such as in the airport or in a coffee shop, or when the battery 184885 4 level is really low, such as less than 10%. A fast charging may be warranted for such occasions.

The wireless device may provide settings that a user can choose whether, when, and/or where the fast charging is enabled or disabled. The option can be location based, time based, battery level based, temperature based, and/or any other suitable conditions. In one example, if it is location based, the user can specify a list of user known locations, such as home, office, etc. for disabling fast charging. The user may also specify a list of user known locations, such as specific airports (e.g., user's frequent airports), for enabling fast charging. In another example, if it is time based, the user may specific a certain time period for disabling fast charging, such as work hours (e.g., weekdays 9 am-5 pm, etc.) and/or bedtime (e.g., 9 pm-6 am). In yet another example, if it is battery level based, the user may specify to enable fast charging when the battery level is below a certain range (e.g., 10%). In yet another example, if it is temperature based, the user may specify to allow fast charging when the battery temperature is below a certain value (e.g., 35° C.).

The system may allow a wireless device user to enable or disable fast charging based on one condition, such as location based only, or based on multiple conditions, such as both location based and time based. However, sometime two conditions may ask for different charging schemes. For example, a wireless device user may choose to disable fast charging at home and enable fast charging in an airport. The wireless device user may also opt to disable fast charging between 9 pm and 6 am. It may happen that the wireless device may be in the airport during nighttime, e.g., 10 pm. Under such conditions, the wireless device user may select which condition has overriding priority. For example, if the wireless device user chooses that the location condition has higher priority than the time condition, then the phone chooses to enable fast charging when it is in the airport at nighttime. An alternative is to choose which charging scheme is more critical. If a wireless device user specify that fast charging is more critical, then if any specified fast charging condition is met, then fast charging will be enabled, regardless if other condition may call for disabling the fast charging. For example, in the case when the wireless device is in the airport while at nighttime, since fast charging is more critical, the wireless device will enable fast charging when plugged in, even though time based condition calls for disabling the fast charging.

In another aspect of the present disclosure, the wireless device may construct a user profile and determine the appropriate charging scheme based on the user profile. A user profile is extracted from the collection of data for a particular user over a period of time. The data are collected through the sensors embedded in the wireless devices, including gyroscope, accelerometer, proximity sensor, barometer, light sensor, position location, WiFi, Bluetooth, even cellular signal, etc. The user profile may be updated over the time when more data are collected.

The user profile may contain varied certain characteristics about an individual user, such as frequent locations (e.g., home, office, etc.), regular schedule (e.g., work hour, sleep hour, break, meal time, etc.), and/or preferences/habits (e.g., fast charging in certain places, certain time, and/or certain battery level). Based on the constructed user profile, the wireless device may enable or disable fast charging by detecting current conditions, such as frequent locations, frequent time periods, battery levels, and/or temperature ranges for enabling or disabling fast charging. For example, if the current time is 10 pm in a weekday, and the user profile indicates that the user usually disables fast charging during this hour, then the wireless device may predict that the user would continue the same approach and would disable the fast charging if the wireless device is plugged in. In another example, if the present location is an airport, and the user profile indicates that the user usually enable fast charging in such a particular location, then the wireless device would enable fast charging if the wireless device is plugged in. In yet another example, the user profile may indicate that the user tends to fast charge the wireless device after 9 pm in weekdays but only after 11 pm in weekends. The wireless device will act accordingly.

The user may override the option provided by the wireless device based on the user profile. This can be done through a setting.

Whether a fast charging is enabled or disabled may be determined by user settings or by a user profile. The wireless device may display a notice whether fast charging is enabled or disabled whenever the wireless is plugged in. The message may include an option for the user to accept the current charging scheme. The user can accept the current charging scheme or to select a different one.

Over the time of charging, the current condition may change. For example, as time elapses, it may be in a period that the charging condition calls for disabling fast charging. In another example, a wireless device may start with fast charging. As charging progresses, the temperature may become high, the battery level may be high enough, or the location has since moved. Therefore, a different charging scheme may be warranted. The wireless device may continue to monitor the current condition, e.g., determining the current condition of the wireless device a second time, and compare the updated current condition with the fast charging condition for enabling or disabling a fast charging, and update the charging scheme accordingly.

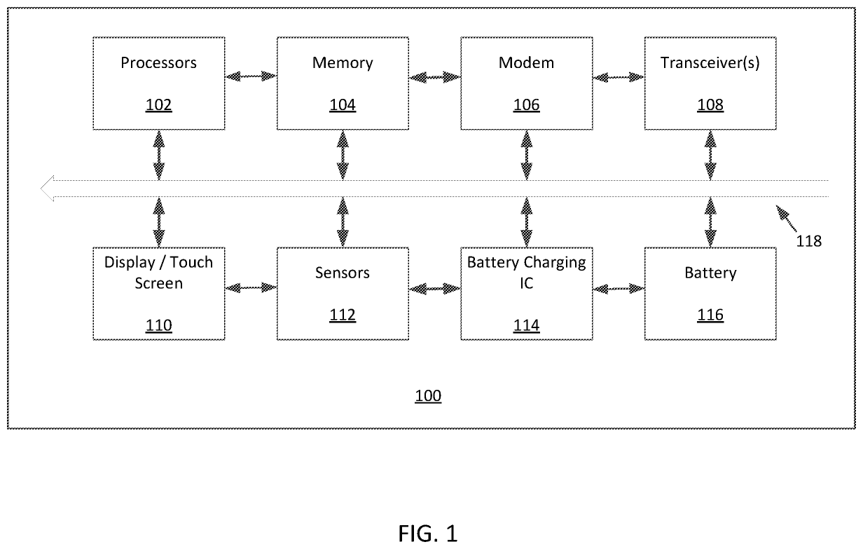

FIG. 1 illustrates an exemplary wireless device according to certain aspects of the present disclosure. The wireless device 100 comprises many components, such as one or more processors 102, memory 104, modem 106, transceiver(s) 108, display/touch screen module 110, a plurality of sensors 112, a battery charging IC 114, a battery 116, to name a few. Some of the components may directly couple to each other, such as the memory 104 couples to the one or more processors 102; some may couple to each other through a bus 118; and some may couple to each other through another component.

The one or more processors 102 may include an application processor, a GPU, a DSP, and/or any other controller(s). The one or more processors 102 may be configured to be a controller for controlling battery charging scheme, such as obtaining a fast charging condition for enabling or disabling a fast charging; determining a current condition of the wireless device; and enabling or disabling the fast charging by comparing the current condition with the fast charging condition for enabling or disabling the fast charging. The one or more processors 102 may be further configured to collect data of the user and develop a user profile based on the collected data. The one or more processors 102 may pass the collected data to a server to develop the user profile.

The memory 104 may couple to the one or more processors 102 to store the code for executing the battery charging scheme control. The memory 104 may also be configured to store the collected data and the user profile. The memory 104 and the one or more processors 102 may couple to allow the user to set up the charging conditions.

The modem 106 and the transceiver(s) 108 are configured to wirelessly communicate with other devices, such as a server.

The display/touch screen module 110 may couple to the one or more processors 102 and/or memory 104 to display message and receive user input. For example, the display/touch screen module 110 may be configured to display a message whether the fast charging is enabled or disabled. The message may comprise an option for user to enable or disable the fast charging.

The sensors 112 may comprise gyroscope, accelerometer, proximity sensor, barometer, light sensor, temperature sensor, position location, WiFi, Bluetooth, and/or cellular signals. The data collected by the sensors 112 are used to develop the user profile. Some of the sensors 112 may be standalone. Some may be embedded inside other components. For example, a temperature sensor may be built inside one or more processors 102 or in the battery 116.

The battery charging IC 114 controls the charging of the battery 116. The one or more processors 102 may control the charging scheme of the battery 116 through the coupling with the battery charging IC 114. In another aspect, the battery charging IC 114 may include a controller that controls the charging scheme of the battery 116.

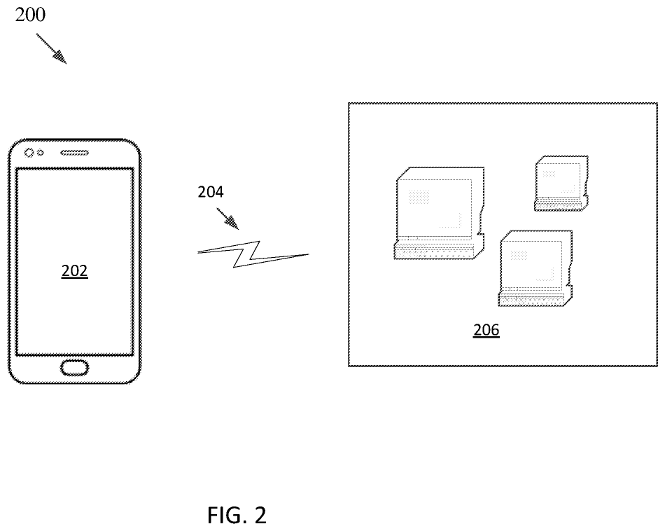

The user profiling may be developed in a server. FIG. 2 illustrates an exemplary system according to certain aspects of the present disclosure. The system 200 comprises a wireless device 202, a server 206, and a communication media 204. The communication media 204 may be Bluetooth, WiFi, cellular communication, or any other suitable medias. The data collected through the sensors of the wireless device 202 are transferred to the server 206 through the communication media 204. At server 206, the user profile may be extracted or developed from the data. The user profile may be sent back to the wireless device 202. The user profile may reside in a memory of the wireless device 202 (e.g., the memory 104). In another aspect, instead of sending back the user profile, the charging condition may be sent back to the wireless device 202.

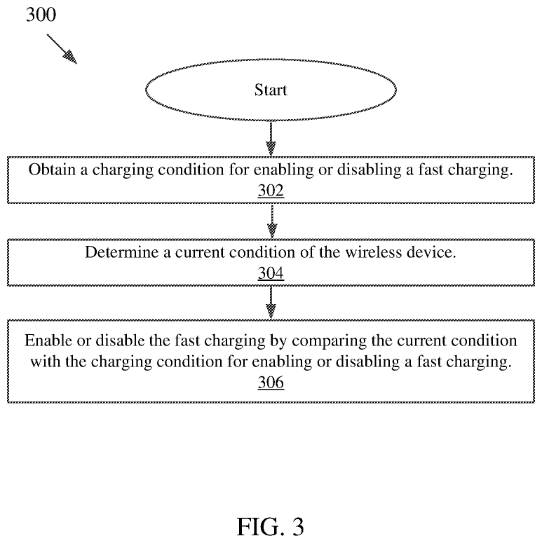

FIG. 3 illustrates an exemplary method 300 for battery charging scheme control according to certain aspects of the present disclosure. At 302, a charging condition for enabling or disabling a fast charging is obtained. The charging condition may be set up by a wireless device user. In another aspect, the charging condition may be derived from a user profile. The user profile is extracted from the collection of data for a particular user over a period of time. The data are collected through the sensors embedded in the wireless devices, including gyroscope, accelerometer, proximity sensor, barometer, light sensor, position location, WiFi, Bluetooth, cellular signal, etc. The user profile may be updated over the time when more data are collected. The user profile may contain certain varied characteristics about an individual user, such as frequent locations (e.g., home, office, etc.), regular schedule (e.g., work hour, sleep hour, break, meal time, etc.), and/or preferences/habits (e.g., fast charging in certain places, certain time, and/or certain battery level).

At 304, a current condition of the wireless device is determined. The current condition may include current location, current time, current temperature, and/or current battery level, etc. The current condition may be obtained through one or more sensors (e.g., the sensors 112).

At 306, the fast charging may be enabled or disabled by comparing the current condition with the charging condition for enabling or disabling the fast charging.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A method for battery charging in a wireless device, comprising:
obtaining a fast charging condition;
determining a current condition of the wireless device; and
enabling or disabling fast charging by comparing the current condition with the fast charging condition.

2. The method of claim 1, wherein the current condition is one of a current location, a current time, a current battery level, and a current temperature.

3. The method of claim 1, wherein the fast charging condition is location based, time based, battery level based, or temperature based.

4. The method of claim 1, wherein the fast charging condition is configured to be set up by a user of the wireless device.

5. The method of claim 1, wherein the fast charging condition is configured to be set up based on a user profile.

6. The method of claim 5, further comprising developing the user profile based on data collected by the wireless device.

7. The method of claim 6, wherein the user profile resides in a memory of the wireless device.

8. The method of claim 6, wherein the developing the user profile is performed by a server.

9. The method of claim 6, wherein the developing the user profile is performed by the wireless device.

10. The method of claim 5, wherein the user profile includes at least one of a frequent location, a frequent time period, a battery level, and a temperature range for enabling or disabling fast charging.

11. The method of claim 1, further comprising displaying a message whether the fast charging is enabled or disabled.

12. The method of claim 11, wherein the message comprises an option for user to enable or disable the fast charging.

13. The method of claim 1, further comprising
determining the current condition of the wireless device a second time; and
enabling or disabling the fast charging by comparing the current condition with the fast charging condition.

14. A wireless device, comprising:
a battery; and
a controller configured to
obtain a fast charging condition;
determine a current condition of the wireless device; and
enable or disable fast charging by comparing the current condition with the fast charging condition.

15. The wireless device of claim 14, wherein the current condition is one of a current location, a current time, a current battery level, and a current temperature.

16. The wireless device of claim 14, wherein the fast charging condition is location based, time based, battery level based, or temperature based.

17. The wireless device of claim 14, wherein the fast charging condition is configured to be set up by a user of the wireless device.

18. The wireless device of claim 14, wherein the fast charging condition is configured to be set up based on a user profile.

19. The wireless device of claim 18, wherein the user profile is developed based on data collected by the wireless device.

20. The wireless device of claim 18, wherein the user profile is developed by a server.

21. The wireless device of claim 18, wherein the controller is further configured to develop the user profile.

22. The wireless device of claim 18, further comprising a memory coupled to the controller, wherein the user profile resides in the memory.

23. The wireless device of claim 18, wherein the user profile includes at least one of a frequent location, a frequent time period, a battery level, and a temperature range for enabling or disabling fast charging.

24. The wireless device of claim 14, further comprising a screen configured to display a message whether the fast charging is enabled or disabled.

25. The wireless device of claim 24, wherein the message comprises an option for user to enable or disable the fast charging.
